(19) United States
(12) Patent Application Publication
(10) Pub. No.: US 2010/0096581 A1
(43) Pub. Date: Apr. 22, 2010

(54) METHOD AND ARRANGEMENT FOR SEPARATING MAGNETIC PARTICLES, MAGNETIC PARTICLES AND USE MAGNETIC PARTICLES

(75) Inventors: Bernhard Gleich, Eindhoven (DE); Jurgen Weizenecker, Eindhoven (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,607

(22) PCT Filed: Dec. 18, 2007
(86) PCT No.: PCT/IB07/55204

§ 371 Date: Dec. 8, 2009

(30) Foreign Application Priority Data
Dec. 20, 2006 (EP) 06126576.5

(51) Int. Cl. H01F 1/00; B03C 1/01; B03C 1/02

(52) U.S. Cl. 252/62.51 R; 209/3; 209/213

(57) ABSTRACT

A method and an arrangement for separating magnetic particles, magnetic particles and the use of magnetic particles are disclosed wherein the method comprises the steps of: —subjecting the magnetic particles to a first magnetic field such that the particle direction of easy magnetization is oriented parallel to the magnetic field vector of the first magnetic field, —subjecting the magnetic particles to a second magnetic field having an orientation rotated about an angle relative to the magnetic field vector of the first magnetic field, —applying a separating force on the magnetic particles.

The present invention relates to a method for separating magnetic particles. Furthermore, the invention relates to an arrangement for separating magnetic particles, to magnetic particles and to the use of magnetic particles.

A method of magnetic particle imaging is known from German Patent Application DE 101 51 778 A1. In the case of the method described in that publication, first of all a magnetic field having a spatial distribution of the magnetic field strength is generated such that a first sub-zone having a relatively low magnetic field strength and a second sub-zone having a relatively high magnetic field strength are formed in the examination zone. The position in space of the sub-zones in the examination zone is then shifted, so that the magnetization of the particles in the examination zone changes locally. Signals are recorded which are dependent on the magnetization in the examination zone, which magnetization has been influenced by the shift in the position in space of the sub-zones, and information concerning the spatial distribution of the magnetic particles in the examination zone is extracted from these signals, so that an image of the examination zone can be formed. Such an arrangement and such a method have the advantage that it can be used to examine arbitrary examination objects—e.g. human bodies—in a non-destructive manner and without causing any damage and with a high spatial resolution, both close to the surface and remote from the surface of the examination object.

The performance of such known arrangement depend strongly on the performance of the tracer material, i.e. the material of the magnetic particles. There is always the need to increase the signal to noise ratio of known arrangements in order to improve the resolution and the application of such a method to further applications.

It is therefore an object of the present invention to provide a method such that improved magnetic particles result, especially for an application in magnetic particle imaging.

The above object is achieved by a method for separating magnetic particles, wherein the magnetic particles comprise a particle direction of easy magnetization, the method comprising the steps of subjecting the magnetic particles to a first magnetic field such that the particle direction of easy magnetization is oriented parallel to the magnetic field vector of the first magnetic field, furthermore subjecting the magnetic particles to a second magnetic field having an orientation rotated about an angle relative to the magnetic field vector of the first magnetic field, and furthermore applying a separating force on the magnetic particles.

The advantage of such a method is that it is possible to obtain magnetic particles having a comparably sharp distribution of the strength of anisotropy of their magnetization, thereby increasing the signal to noise ratio when used in the context of magnetic particle imaging techniques. In the context of the present invention, the term “strength of anisotropy of the magnetization of magnetic particles” signifies the exterior magnetic field (exterior relative to the magnetic particle or particles) that is necessary in order to change significantly the magnetization of the magnetic particle or particles. This interpretation is strongly correlated to other definitions relatable to the term “anisotropy of magnetic particles” or “field of anisotropy”, e.g. different energies related to different spatial directions (energy landscape) expressed by means of a plurality of constants of anisotropy. In the context of the present invention, the term “strength of anisotropy of the magnetization of magnetic particles” is related to a quantifiable parameter. By the term “orientation of the particle direction of easy magnetization parallel to the magnetic field vector of the first magnetic field” it is to be understood that the direction of easy magnetization of a plurality of magnetic particles is preferably oriented parallel to the magnetic field vector of the first magnetic field in the sense of a Boltzmann distribution.

According to a preferred embodiment of the present invention, the second magnetic field comprises a magnetic field gradient for applying the separation force on the magnetic particles. Thereby, a comparably simple method for efficiently separate magnetic particles depending upon the strength of anisotropy of their magnetization is possible to implement. In this embodiment, it is furthermore preferred to provide the first magnetic field as a homogeneous magnetic field. Thereby, it is possible to obtain a very well defined orientation of the particle direction of easy magnetization parallel to the magnetic field vector of the first magnetic field without applying forces in unwanted or random directions.

According to another preferred embodiment of the present invention, the separating force on the magnetic particles is applied by a third magnetic field comprising a magnetic field gradient. Thereby, it is preferably possible to provide the second magnetic field in the form of a homogeneous magnetic and to separate the magnetic particles by the third magnetic field, thereby increasing the separation power of the inventive method relative to the situation where the second magnetic field comprises the magnetic field gradient and applies the separating force.

According to a further preferred embodiment of the present invention, the magnetic particles are separated depending upon the strength of anisotropy of their magnetization. This allows for the generation of magnetic particles having a well defined strength of anisotropy of their magnetization, i.e. a comparably sharply delimited distribution of this property.

According to still a further preferred embodiment of the present invention, the magnetic particles are mono domain magnetic particles, also called single domain magnetic particles.

According to an embodiment of the present invention, it is preferred that the second magnetic field or the third magnetic field is provided as the magnetic field produced by a current flowing in a single wire. Thereby, it is possible to produce a gradient magnetic field in a relatively simple manner.

Furthermore, it is preferred according to one embodiment of the present invention, that the first magnetic field is inactivated when the second magnetic field is activated and vice versa. Thereby, it is advantageously possible to selectively influence magnetic particles having a defined strength of anisotropy of their magnetization such that they can be efficiently separated.

Furthermore, it is preferred according to still another embodiment of the present invention, that the frequency of activation and inactivation of the first and second magnetic fields is comprised in the range of about 1 kHz and about 100 MHz, preferably in the range of about 200 kHz and about 5 MHz. Thereby, it is advantageously possible to adapt the inventive method to a plurality of different magnetic particles, e.g. of different size and/or of different environment of the magnetic particles.

The invention further relates to an arrangement for separating magnetic particles, the arrangement comprising a fluid conduit, a first magnetic field generating means of generating a first magnetic field and a second field generating means for generating a second magnetic field, wherein the second magnetic field is provided having an orientation rotated about an angle relative to the magnetic field vector of the first magnetic field.

With the inventive arrangement, it is advantageously possible to provide a simple and efficient separatio of magnetic particles depending upon the strength of anisotropy of their magnetization.

The present invention is also related to magnetic particles having a specified strength of anisotropy of their magnetization and the use of such magnetic particles. Preferably the strength of anisotropy of the magnetization is provided in the range of about 1 mT to about 10 mT, wherein the standard deviation of the strength of anisotropy of their magnetization is less than 1 mT, preferably less than 0.5 mT, most preferably less than 0.25 mT. With such particles, it is possible to enhance the signal to noise ratio in the application of magnetic particle imaging provided that the external magnetic field that is experienced by the particles is oriented in a specific range of angles relative to the direction of the easy magnetization (easy axis) of the magnetic particles. Generally in the context of magnetic particle imaging, it is preferred to use larger particles as such larger magnetic particles potentially have a larger possible magnetization which in turn can lead to a higher signal-to-noise ratio at the detection stage. Nevertheless, the size of the magnetic particles is limited because larger particles attract each other due to their magnetic moment and form cluster of magnetic particles, almost invisible to the method of magnetic particle imaging. With the possibility to precisely separate magnetic particles having a defined strength of anisotropy of their magnetization, it is possible to use comparably small particles producing still a comparably high signal to noise ratio.

The magnetic field strength mentioned in the context of the present invention can also be specified in tesla. This is not correct, as tesla is the unit of the magnetic flux density. In order to obtain the particular magnetic field strength, the value specified in each case still has to be divided by the magnetic field constant μ₀.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

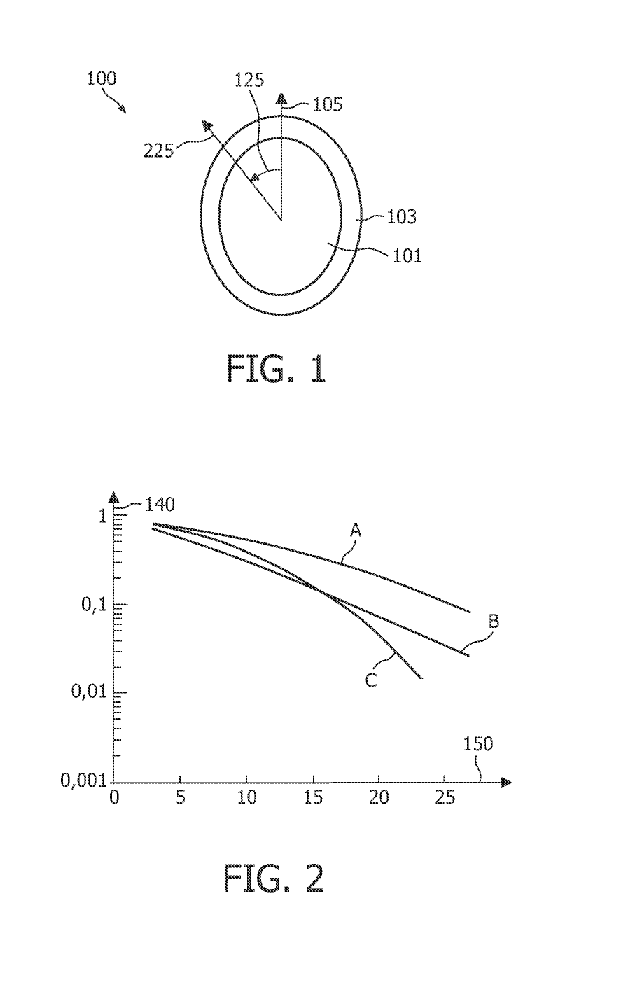

FIG. 1 illustrates an enlarged view of a magnetic particle present in the region of action.

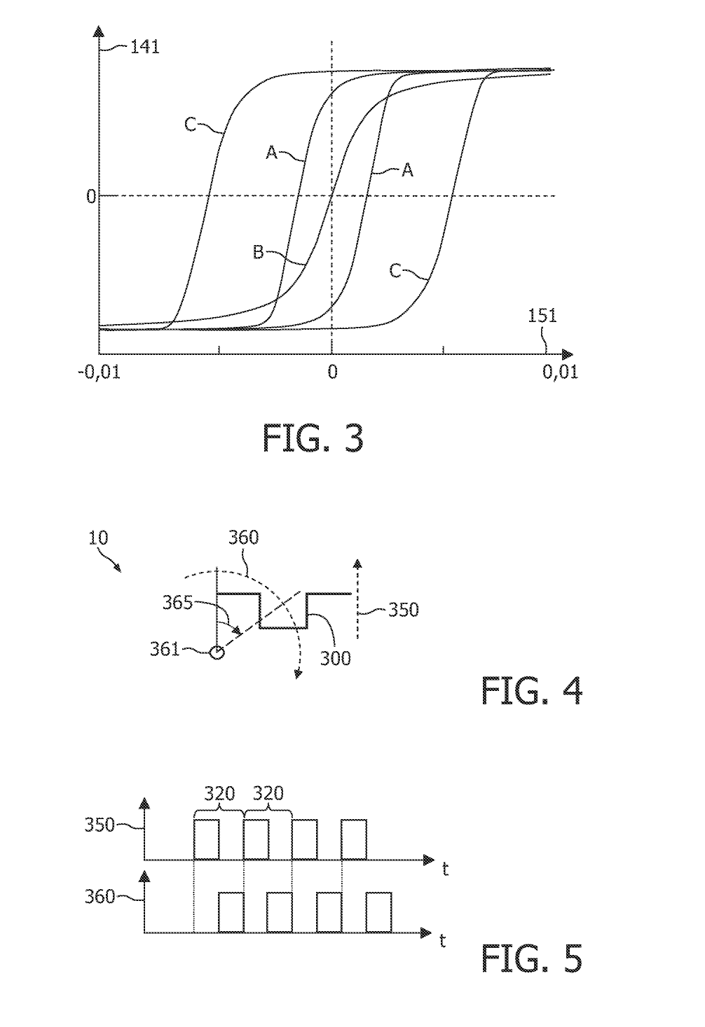

FIGS. 2 and 3 illustrate diagrams of the relative signal strength and of the hysteresis behavior of magnetic particles of three different shapes.

FIG. 4 illustrates schematically a sectional view of an arrangement for separating magnetic particles.

FIG. 5 illustrates the first and second magnetic fields in the time domain.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

FIG. 1 shows an example of a magnetic particle 100 of the kind used together with an arrangement 10 of the present invention. It comprises for example a mono domain magnetic material 101, e.g. of the ferromagnetic type. This magnetic material 101 may be covered, for example, by means of a coating layer 103 which protects the particle 100 against chemically and/or physically aggressive environments, e.g. acids. The magnetic field strength of an external magnetic field required for the saturation of the magnetization of such particles 100 is dependent on various parameters, e.g. the diameter of the particles 100, the used magnetic material 101 and other parameters. According to the present invention, the magnetic particles 100 are magnetically anisotropic, i.e. they have an anisotropy of their magnetization. Such an anisotropy can e.g. be provided by means of shape anisotropy and/or by means of crystal anisotropy and/or by means of induced anisotropy and/or by means of surface anisotropy. The magnetic particle 100 comprises a direction of easy magnetization, also called easy axis 105.

In arrangements and methods related to magnetic particle imaging—e.g. known from DE 101 51 778 which is hereby incorporated by reference in its entirety—a so called magnetic drive field produces a magnetic drive vector 225 corresponding to the direction of the external magnetic field that the magnetic particle 100 experiences. If mono domain magnetic particles having an anisotropy of their magnetization are exposed to an external magnetic field, the response of the magnetic particles depend on the direction of the field with respect to the direction of easy magnetization (easy axis). If the external magnetic field is perpendicular to the easy axis, the response signal is comparably low. If the external magnetic field is parallel to the easy axis, the response signal is much larger. Astonishingly, the signal is optimal if the external magnetic field that the magnetic particles 100 experience is oriented in a specific angle relative to the easy axis of the magnetic particle 100. According to the present invention, the magnetic drive vector 225 should be oriented with a relatively high probability in a special angle 125 relative to the direction of easy magnetization 105 of the magnetic particle 100. Thereby, the magnetization signal of the magnetic particle 100 in a magnetic particle imaging arrangement is enhanced.

In the example shown in FIG. 1, the anisotropy of the magnetic particle 100 is provided by means of shape anisotropy. The magnetic particle 100 is quasi spherical, only along the direction of it longest extension (also called z-direction; in FIG. 1 the up-down-direction) it is longer than in the two directions (also called x-direction and y-direction) of the plane perpendicular to its longest extension. For example, the longest extension of the magnetic particle 100 is 31 nm and the extension in the two other directions (x- and y-direction) of the magnetic particle 100 is 30 nm. In the context of the present invention, the dimensions given of the magnetic particles 100 correspond to the dimensions of the magnetic material 101 of the magnetic particles 100.

According to the present invention, it is preferred to use a well defined strength of anisotropy of the magnetization of the magnetic particles 100 of about 1 mT to about 10 mT, preferably of about 3 mT to about 5 mT. In the example given, this anisotropy could be exceeded if the shape anisotropy would be enhanced to a length of the particles (along their longest direction) of 32 nm while still having a diameter in the other directions (x- and y-directions) of 30 nm. This is also represented in FIGS. 2 and 3.

FIG. 2 represents diagrams of the relative signal strength 140 of magnetic particles 100 of three different shapes. The relative signal strength 140 is shown for several harmonics of different order 150. For all three particles, the signal strength 140 decreases when the ordinal number of harmonic increases. Nevertheless, the decrease in signal strength 140 is smaller for the magnetic particles 100 represented by the curve A than the magnetic particles 100 represented by the curves B and C. The curve A corresponds to magnetic particles 100 having a shape anisotropy due to their extension in the x-, y- and z-direction of 30 nm, 30 nm and 31 nm respectively. The curve B corresponds to magnetic particles 100 having a shape anisotropy due to their extension in the x-, y- and z-direction of 30 nm, 30 nm and 30 nm respectively. The curve C corresponds to magnetic particles 100 having a shape anisotropy due to their extension in the x-, y- and z-direction of 30 nm, 30 nm and 32 nm respectively. The best relative signal strength 140 is therefore achieved with the magnetic particles corresponding to the curve A.

FIG. 3 represents diagrams of the hysteresis behavior of the three particles A, B and C mentioned above. The relative strength of the magnetization 141 (in arbitrary units) is shown depending on the strength of the external magnetic field 151 given in tesla. It can be seen that the hysteresis behavior of the particles A is such that energy needed to reverse the magnetization is present but comparably low such that a change (or a reversal) in magnetization of the mono domain magnetic particles 100 (Néel rotation) can be performed very quickly.

In FIG. 4, an embodiment of an arrangement 10 according to the present invention is schematically shown where a fluid conduit 300 contains a fluid (not shown) comprising magnetic particles 100. The fluid conduit 300 extends in the example perpendicular to the plane of the drawing. A first magnetic field 350 is represented by an arrow. This first magnetic field 350 is especially oriented perpendicular to the extension of the fluid conduit 300, e.g. vertically. A second magnetic field 360 is also represented by an arrow. In the example given, the second magnetic field 360 is provided having a magnetic field gradient and is generated, e.g. by means of a single wire 361 where a current flows. Thereby, the second magnetic field 360 is at least partially oriented in an angle 365 relative to the (former) orientation of the first magnetic field 350 and therefore also relative to the preferred orientation of the direction 105 of easy magnetization of the particles 100. The angle 365 between the first magnetic field 350 and the second magnetic field 360 is defined according to the present invention as being the acute angle included by the directions of the first and second magnetic field 350, 360 (regardless of the orientations of the these magnetic fields). Nevertheless, in order to provide a reversal of magnetization of the magnetic particles 100, the angle between the orientation of the first magnetic field 350 and the orientation of the second magnetic field 360 has to exceed 90 degrees.

In FIG. 5, temporal diagrams of the evolution of the first magnetic field 350 and of the second magnetic field 360 are shown. It can be seen that the first and second magnetic fields 350, 360 alternate such that the first magnetic field 350 is activated when the second magnetic field 360 is deactivated and that the second magnetic field 360 is activated when the first magnetic field 350 is deactivated, thereby performing cycles 320 of activation and deactivation. In each such cycle 320 of activation and deactivation of the first and second magnetic field 350, 360, the magnetic particles 100 are oriented by the first magnetic field 350 parallel to the vector of magnetic field strength of the first magnetic field 350 (represented in FIG. 4). The second magnetic field 360 is at least partly oriented in the angle 365 relative to the former orientation of the first magnetic field 350. The temporal variation of the first and second magnetic field 350, 360 can be provided differently than the rectangular pulses shown in FIG. 4, e.g. sinusoidal half waves, triangularly shaped or the like.

In this configuration, a separation of the magnetic particles 100 can be achieved due to a quicker or slower reorientation of the magnetization of such magnetic particles 100 having depending of the strength of anisotropy of their magnetization. The magnetic particles out of the plurality of magnetic particles 100 are attracted (e.g. in the direction towards the single wire 361, i.e. in the direction of a stronger second magnetic field 360) that show a quicker reorientation of their magnetization in the presence of the magnetic field gradient of the second magnetic field 360 whereas magnetic particles showing a slower reorientation of their magnetization need a longer time in order to reverse their magnetization. During this time interval (without having reversed their magnetization) these magnetic particles are repelled by the magnetic field gradient of the second magnetic field 360. By choosing the correct angle 365, the possibility to separate between these two behaviours can be enhanced.

The separation can e.g. be performed by means of a chromatographic method, for example such that liquid containing the magnetic particles 100 and liquid without the magnetic particles 100 is provided in an alternating manner in the fluid conduit such that different quantities of liquid containing the magnetic particles 100 are separated from each other by liquid without the magnetic particles 100. When such a quantity of liquid containing the magnetic particles 100 is flowing along the fluid conduit 300 in the presence of the alternating magnetic fields 350, 360, then the magnetic particles 100 having a defined strength of anisotropy of their magnetization are e.g. attracted towards one of the walls of the fluid conduit 300, thereby flowing more slowly than the rest of the magnetic particles 100. By means of such a divergence of the quantities of liquid containing the magnetic particles 100 while flowing along the fluid conduit 300, a spatial separation of the magnetic particles 100 depending upon the strength of anisotropy of their magnetization is realised. The desired magnetic particles 100 can therefore be easily separated from the residual magnetic particles 100. Many different separation methods of this kind using chromatographic principles are known.

Therefore, the construction of corresponding separation devices need not be further elaborated herein.

In a further embodiment (not shown) of the method according to the present invention, a first magnetic field, a second magnetic field and a third magnetic field are alternately present (similar to the alternating first and second magnetic field of the embodiment of FIG. 5). In the further embodiment, the first magnetic field and the second magnetic field are preferably homogeneous and are oriented such that the second magnetic field is rotated about the angle 365 relative to the first magnetic field and therefore able to reverse the magnetization of the magnetic particles. In the further embodiment, the third magnetic field comprises a magnetic field gradient and therefore corresponds to the second magnetic field in the embodiment of FIG. 5. After the application of the first magnetic field during a period of time, then the application of the second magnetic field during a period of time, there exists a higher probability for such magnetic particles 100 having a defined strength of anisotropy of their magnetization to be oriented antiparallel to the (former) direction of the first magnetic field. The third magnetic field then can be applied such that the magnetic field gradient is oriented parallel to the former direction of the first magnetic field thereby increasing the separation power (forces on the magnetic particles in the gradient magnetic field) relative to the embodiment of FIG. 5.

According to both described embodiments of the method according to the present invention, it is possible to repeat the passages of the fluid conduit for a plurality of magnetic particles 100 and thereby to obtain a better (sharper) distribution of the strength of anisotropy of the magnetization of the magnetic particles 100. Thereby, it is possible to obtain specific values of the standard deviation in the distribution of the strength of anisotropy of the magnetization of the magnetic particles obtained.

1. A method for separating magnetic particles (100), wherein the magnetic particles (100) comprise a particle direction (105) of easy magnetization, the method comprising the steps of:
subjecting the magnetic particles (100) to a first magnetic field (350) such that the particle direction (105) of easy magnetization is oriented parallel to the magnetic field vector of the first magnetic field (350),
subjecting the magnetic particles (100) to a second magnetic field (360) having an orientation rotated about an angle (365) relative to the magnetic field vector of the first magnetic field (350),
applying a separating force on the magnetic particles (100).

2. A method according to claim 1, wherein the second magnetic field (360) comprising a magnetic field gradient for applying the separating force on the magnetic particles (100).

3. A method according to claim 1, wherein the separating force on the magnetic particles (100) is applied by a third magnetic field comprising a magnetic field gradient.

4. A method according to claim 1, wherein the magnetic particles (100) are separated depending upon the strength of anisotropy of their magnetization.

5. A method according to claim 1, wherein the magnetic particles (100) are mono domain magnetic particles (100).

6. A method according to claim 2, wherein the first magnetic field (350) is a homogeneous magnetic field.

7. A method according to claim 3, wherein the first magnetic field (350) and the second magnetic field (360) are homogeneous magnetic fields.

8. A method according to claim 1, wherein the second magnetic field (360) or the third magnetic field is provided as the magnetic field produced by a current flowing in a single wire (361).

9. A method according to claim 1, wherein the first magnetic field (350) is inactivated when the second magnetic field (360) is activated and vice versa.

10. A method according to claim 1, wherein the frequency of activation and inactivation of the first and second magnetic fields (350, 360) is comprised in the range of about 1 kHz and about 100 MHz, preferably in the range of about 200 kHz and about 5 MHz.

11. An arrangement (10) for separating magnetic particles (100), the arrangement (10) comprising a fluid conduit (300), a first magnetic field generating means for generating a first magnetic field (350) and a second field generating means (361) for generating a second magnetic field (360), wherein the second magnetic field (360) is provided having an orientation rotated about an angle (365) relative to the magnetic field vector of the first magnetic field (350).

12. Magnetic particles (100) having a specified strength of anisotropy of their magnetization in the range of about 1 mT to about 10 mT, wherein the standard deviation of the strength of anisotropy of the magnetization is less than 1 mT, preferably less than 0.5 mT, most preferably less than 0.25 mT.

13. The use of magnetic particles (100) according to claim 12 for magnetic particle imaging.
